(19) United States
(12) Patent Application Publication
(10) Pub. No.: US 2010/0123783 A1
(43) Pub. Date: May 20, 2010

(54) GAIN CALIBRATION DEVICE AND METHOD OF GAIN CALIBRATION

(75) Inventor: Yi-chang LIN, Tantz Shiang (TW)

Correspondence Address: Flash Intellectual Property, Inc.;Attn. Cheng-Ju Chiang, P.O. Box 766, Chino, CA, 91708, US

(73) Assignee: ASIA OPTICAL CO., INC., Tantz Shiang (TW)

(21) Appl. No.: 12/618,674

(22) Filed: Nov. 13, 2009

(30) Foreign Application Priority Data
Nov. 14, 2008 (TW) 097144200

(51) Int. Cl. H04N 17/00; H04N 5/235

(52) U.S. Cl. 348/180; 348/229.1; 348/E05.037; 348/E17.001

(57) ABSTRACT

A gain calibration device includes an integrator, a first register, a controller, and a second register. When an optical image stabilizer is activated, the controller determines whether a current magnification of an image processing equipment is the same as a previous magnification. When the current magnification is not the same as the previous magnification, the controller reads the current magnification. Then the first registers stores a reference magnification, which is corresponding to a reference gain value of the optical image stabilizer. The second register temporarily stores a current gain value. Based on the reference magnification, the reference gain value and the current magnification, the controller calculates the current gain value corresponding to the current magnification for compensating the optical image stabilizer.

### BACKGROUND OF THE INVENTION

1. Field of the Invention

The present invention generally relates to a gain calibration device and a method of gain calibration, and particularly relates to a gain calibration device and a method of gain calibration adapted for an optical image stabilizer.

2. Description of Prior Art

With the rapid development of information technology, more and more types of consumer electronics products, such as computers, LCD TVs, videos, digital cameras, have been popularized. Especially, with light, thin, short, small features, digital camera is very convenient to carry, and photographs are also getting higher and higher pixel. To get a better quality shot, during finding a view, it is important to adjust an image zoom position inside the lens (for example, charge-coupled device (CCD)) back and forth, that is, it requires adjusting the magnification of the camera lens to shoot people or objects with more clearly focus. At this point, based on the gyro signal gain adjustment, the camera can be in a stable condition by an optical image stabilizer. However, the gyro signal gain value and the camera magnification influence each other, and therefore, when the magnification of the camera changes, the gain value adjustment should be changed simultaneously.

In prior arts, within a specified range of magnification, the camera uses a fixed gain value. Taking a camera having a magnification of 12× as an example, when magnification of the camera lens is set to 1× to 3×, the gain value is 10; when magnification of the camera lens is set to 4× to 6×, the gain value is 20; and when magnification of the camera lens is set to 7× to 12×, the gain value is 30. Although three different magnifications are included in the range of 1× to 3×, the gain value maintains same, and this is similar in the magnification ranges of 4× to 6× and 7× to 12×, where the gain values are same respectively. Consequently, gyro signal cannot be properly compensated, resulting in poor image quality. In view of this, it is necessary to develop a novel optical image stabilizer, to solve the above-mentioned problem.

### SUMMARY OF THE INVENTION

The object of the present invention is to provide a gain calibration device and a method of gain calibration, which are capable of compensating, rapidly and accurately, a gain value of an optical image stabilizer of an image processing equipment to improve the image quality.

To achieve the above objectives, the invention provides a gain calibration device, which comprises an integrator, a first register, a controller, and a second register. The gain calibration device is employed in an optical image stabilizer (OIS) of an optical imaging system. The integrator is provided for receiving a gyro signal and integrating the gyro signal to form integral information. The first register is used to store the gyro signal, the integral information, and at least one reference magnification of the image processing equipment, wherein the at least one reference magnification is corresponding to at least one reference gain value of the optical image stabilizer. The second register functions for temporary storage of a current gain value. The controller determines whether a current magnification of the image processing equipment is the same as a previous magnification. When the current magnification is not the same as the previous magnification, the controller reads the current magnification from the image processing equipment. Based on the at least one reference magnification, the at least one reference gain value and the current magnification, the controller calculates the current gain value corresponding to the current magnification by interpolation, and replaces a last current gain value temporarily stored in the second register with the current gain value. When the current magnification is the same as the previous magnification, the controller compensates continually the optical image stabilizer by the gain value corresponding to the current magnification.

The present invention also provides a method of gain calibration, which comprises the following steps:

(a) the image processing equipment activating stabilizing mechanism of the optical image stabilizer;

(b) the integrator integrating a gyro signal to form integral information;

(c) the first register storing the gyro signal and the integral information;

(d) the controller determining whether a current magnification of the image processing equipment is the same as a previous magnification, wherein when the current magnification is not the same as the previous magnification, the controller reads the current magnification from the image processing equipment, and when the current magnification is the same as the previous magnification, the controller compensates continually the optical image stabilizer by the gain value corresponding to the current magnification and performs continually the step (d) for determination of magnification changes;

(e) the first registers storing at least one reference magnification of the image processing equipment, the at least one reference gain value of the optical image stabilizer being corresponding to the at least one reference magnification of the optic image stabilizer, the second register storing a current gain value;

(f) based on the at least one reference magnification, the at least one reference gain value, and the current magnification, the controller calculating the current gain value corresponding to the current magnification by interpolation, and replacing a last current gain value temporarily stored in the second register with the current gain value; and

(k) the second register compensating continually the optical image stabilizer by the current gain value corresponding to the current magnification.

The present invention may best be understood through the following description with reference to the accompanying drawings, in which:

### BRIEF DESCRIPTION OF THE DRAWINGS

FIG. 1 is a block diagram of an optical image stabilizer having a gain calibration device in accordance with an embodiment of the present invention;

FIG. 2 is a curve diagram illustrating characteristics of magnification of the image processing system shown in FIG. 1 in relation to gain value of the optical image stabilizer; and

FIGS. 3A-3D are flow charts of a method of gain calibration according to embodiments of the present invention.

### DETAILED DESCRIPTION OF THE PREFERRED EMBODIMENT

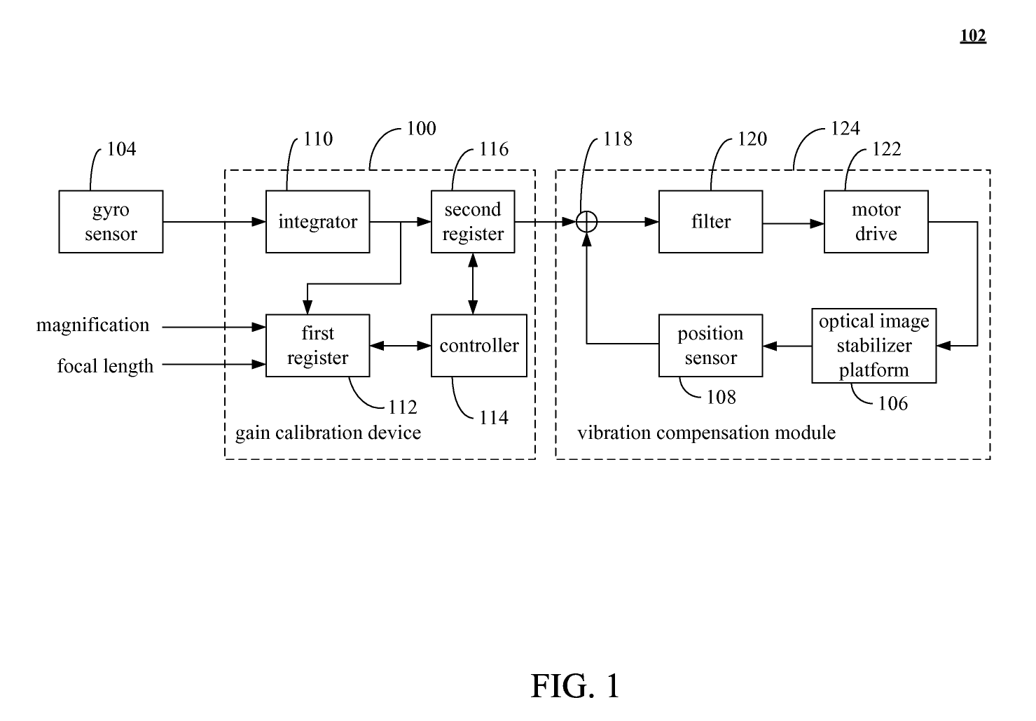

Referring to FIG. 1, which shows a block diagram of an optical image stabilizer 102 having a gain calibration device 100 in accordance with an embodiment of the present invention, the gain calibration device 100 couples a gyro sensor 104 to a vibration compensation module 124. The gain calibration device 100 outputs a gain-adjusted gyro signal to the vibration compensation module 124. The gain calibration device 100 is employed in an optical image stabilizer (OIS) of an image processing equipment, such as a digital camera, a digital videos, or any other image processing equipment having an optical image stabilizer. The gain calibration device 100 comprises an integrator 110, a first register 112, a controller 114, and a second register 116. In an embodiment, the gain calibration device 100 is implemented by for example any of a micro control unit (MCU), a digital signal processor (DSP), a central processing unit (CPU), a complex programmable logic device (CPLD), a field programmable gate array (FPGA), and a system on-chip (SOC), or any combination of the above implementations. The vibration compensation module 124 comprises an optical image stabilizer platform 106, a position sensor 108, a summing device 118, a filter 120, and a motor drive 122.

In the gain calibration device 100, the integrator 110 receives a gyro signal and performs integration on the gyro signal to form integral information. In an embodiment, the integrator 110 calculates the integral of the gyro signal (such as angular velocity) with reference to time, so that the unit of the integral information is the same as the unit of output from the position sensor 108. The first register 112 is used to store the gyro signal, the integral information, and at least one reference magnification of the image processing equipment, wherein the at least one reference magnification is corresponding to at least one reference gain value of the optical image stabilizer 102. The second register 116 functions for temporary storage of a current gain value. The controller 114 determines whether a current magnification of the image processing equipment is the same as a previous magnification. When the current magnification is not the same as the previous magnification, the controller 114 reads the current magnification from the image processing equipment. Based on the at least one reference magnification, the at least one reference gain value, and the current magnification, the controller 114 calculates the current gain value corresponding to the current magnification by interpolation, and replaces a last current gain value temporarily stored in the second register with the current gain value, so that the second register 116 compensates and calibrates the optical image stabilizer 102 by the calculated current gain value. On the other hand, when the current magnification is the same as the previous magnification, the controller 114 compensates continually the optical image stabilizer 102 by the gain value corresponding to the current magnification.

It should be noted that, the first register 112 and the second register 116 can be for example two different memory sections or two different fields in a same storage component, for rapid read of the gyro signal (S_{gyro}), the integral information, the reference magnification, the reference gain value, the current magnification, and the current gain value, or alternatively, they can be, for example, memory sections or fields of two different storage components. Examples of the storage components include memories and memory cards.

In the vibration compensation module 124, the position sensor 108 is provided for sensing the optical image stabilizer platform 106 to form a position signal, thereby compensating the optical image stabilizer platform 106. The summing device 118 is provided for calculating the amount of compensation of adjusted gyro signal (S_{gyro}) and the position signal. The filter 120 is provided for filtering noises generated by the adjusted gyro signal (S_{gyro}) and the position signal. Based on filtered gyro signal (S_{gyro}) and filtered position signal, the motor drive 122 forms a drive signal to drive the optical image stabilizer platform 106.

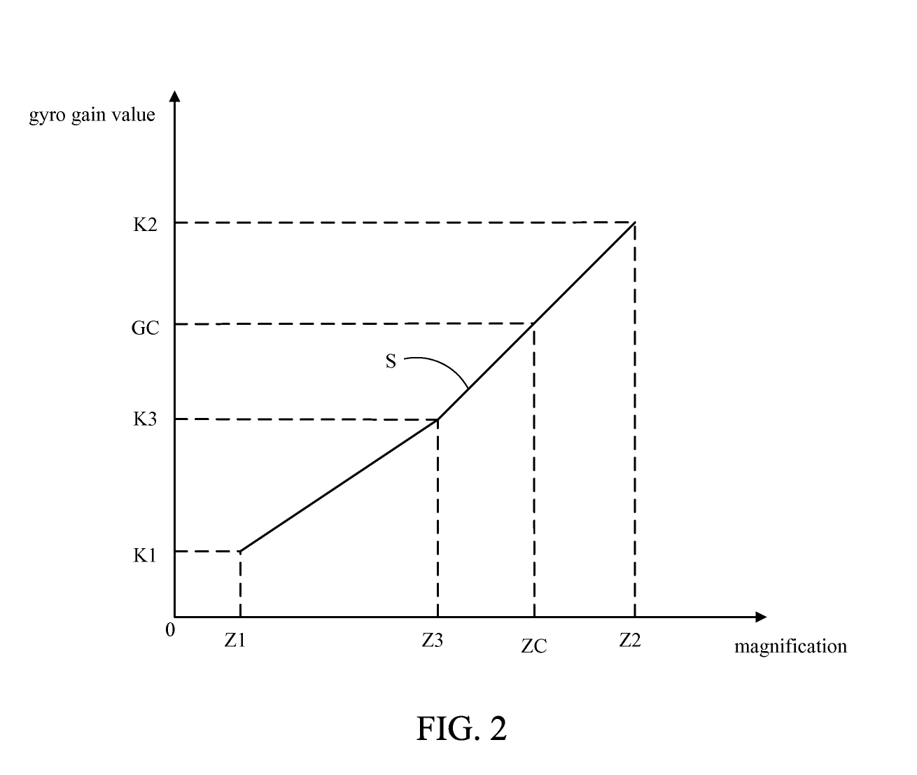

Referring to FIGS. 1 and 2, FIG. 2 is a curve diagram illustrating characteristics of magnification of the image processing equipment in relation to gain value of the optical image stabilizer. In a first embodiment, the first register 112 also stores current focal length of the current magnification and reference focal length of the reference magnification of the image processing equipment. Based on the ratio of the current focal length (fc) to the reference focal length (fr) multiplied by the reference gain value (Z2), for example the focal length (fr) of the maximum magnification, the controller 114 calculates the current gain value (GC), which can be expressed by the following equation: GC=(fc/fr)*Z2.

In a second embodiment, the first register 112 further stores a first reference magnification (Z1) and a second reference magnification (Z2) of the image processing equipment, wherein the first reference magnification (Z1) and the second reference magnification (Z2) are corresponding to a first reference gain value (K1) and a second reference gain value (K2) of the optical image stabilizer 102, respectively. Based on the first reference magnification (Z1), the second reference magnification (Z2), the first reference gain value (K1), the second reference gain value (K2), and the current magnification (ZC), the controller 114 calculates the current gain value (GC) corresponding to the current magnification (ZC) by interpolation. The first reference magnification (Z1) is, for example, the minimum magnification of the image processing equipment and the second reference magnification (Z2) is the maximum magnification of the image processing equipment. The current gain value (GC) calculation equation is as follows: GC=K1*[(Z2−Z1)/(ZC−Z1)].

Based on the minimum magnification, the maximum magnification, the first reference gain value (K1), the second reference gain value (K2), and multiple additional current magnifications (ZC), the controller 114 calculates multiple additional current gain values (GC) corresponding to each of the multiple additional current magnifications (ZC) by interpolation, and the controller 114 establishes a look-up table with the current magnifications (ZC) and the current gain values (GC). The look-up table is stored in the first register 112. Thus, when the image processing equipment is adjusted to a current magnification (ZC), a current gain (GC) corresponding to the current magnification (ZC) is used to compensate the optical image stabilizer 102.

In the third embodiment, the first register 112 stores a first reference magnification (Z1), a second reference magnification (Z2), and a third reference magnification (Z3) of the image processing equipment, wherein the first reference magnification (Z1), the second reference magnification (Z2), and the third reference magnification (Z3) are corresponding to a first reference gain value (K1), a second reference gain value (K2), and a third reference gain value (K3) of the optical image stabilizer 102, respectively. The first reference magnification (Z1) is, for example, the minimum magnification of the image processing equipment and the second reference magnification (Z2) is the maximum magnification of the image processing equipment.

The controller 114 determines whether the current magnification (ZC) is between the first reference magnification (Z1) and the third reference magnification (Z3) or between the second reference magnification (Z2) and the third reference magnification (Z3). When the current magnification (ZC) is between the first reference magnification (Z1) and the third reference magnification (Z3), the controller 114, based on the first reference magnification (Z1), the third reference magnification (Z3), the first reference gain value (K1), the third reference gain value (K3), and the current magnification (ZC), calculates the current gain value (GC) corresponding to the current magnification (ZC) by interpolation. The current gain value (GC) is calculated by an equation as follows: GC=K1*[(Z3−Z1)/(ZC−Z1)]. When the current magnification (ZC) is between the second reference magnification (Z2) and the third reference magnification (Z3), the controller 114, based on the second reference magnification (Z2), the third reference magnification (Z3), the second reference gain value (K2), the third reference gain value (K3), and the current magnification (ZC), calculates the current gain value (GC) corresponding to the current magnification (ZC) by interpolation. The current gain value (GC) is calculated by an equation as follows: GC=K3*[(Z2−Z3)/(ZC−Z3)].

During gain calibration, the gain calibration device 100 of the present invention employs the controller 114 to calculate different gyro gain value corresponding to each magnification, and each magnification corresponds to a different focal length. The present invention uses focal length and gain value of one magnification to quickly calculate a gain value of another magnification by interpolation, or uses one magnification or a number of different ranges of magnification to accurately calculate a gain value of another magnification. Consequently, the present invention can calibrate the gain value of each magnification and can effectively compensate gain of the optical image stabilizer 102. Especially, when in the high-magnification state, gain value changes more significantly with the magnification. The present invention utilizes calculation or looks up a look-up table to associate each magnification with a gain value, thereby calibrating effectively gain value of the optical image stabilizer 102.

Referring to FIGS. 1, 2, and 3A-3D, FIGS. 3A-3D are flow charts of a method of gain calibration according to embodiments of the present invention. The gain calibration device 100 comprises the integrator 110, the first register 112, the controller 114, the second register 116, the summing device 118, the filter 120, and the motor drive 122. The method of gain calibration is employed in the optical image stabilizer 102 of the image processing equipment and comprises the following steps:

Step S300: The image processing equipment activates the stabilizing mechanism of the optical image stabilizer 102.

Step S302: The integrator 110 integrates a gyro signal to form integral information.

Step S304: The first register 112 stores the gyro signal and the integral information.

Step S306: The controller 114 determines whether a current magnification (ZC) of the image processing equipment is the same as a previous magnification, wherein when the current magnification (ZC) is not the same as the previous magnification, the controller 114 reads the current magnification (ZC) from the image processing equipment, and when the current magnification (ZC) is the same as the previous magnification, the controller compensates continually the optical image stabilizer 102 by the gain value corresponding to the current magnification (ZC) and performs continually Step S306 for determination of magnification changes.

S308: The first registers 112 stores at least one reference magnification of the image processing equipment, the at least one reference magnification corresponding to at least one reference gain value of the optical image stabilizer 102, the second register 116 storing a current gain value.

Step S310: Based on the at least one reference magnification, the at least one reference gain value, and the current magnification (ZC), the controller 114 calculates the current gain value (GC) corresponding to the current magnification (ZC) by interpolation, and replacing a last current gain value temporarily stored in the second register 116 with the current gain value.

Step S312: The second register 116 compensates gain of the optical image stabilizer 102 by the calculated current gain value (GC).

Step S314: Capturing an image is performed.

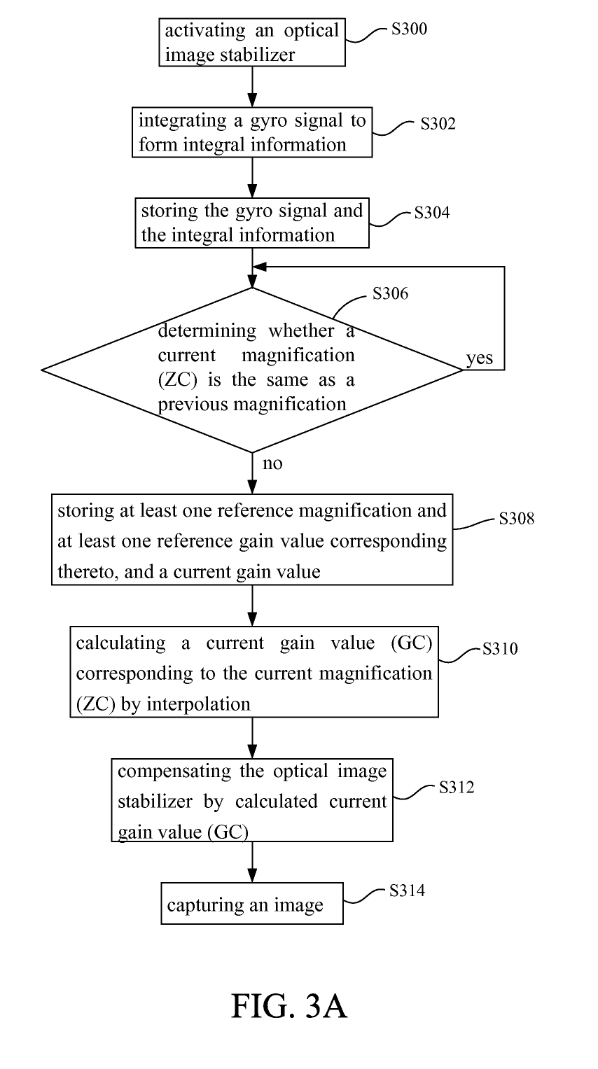

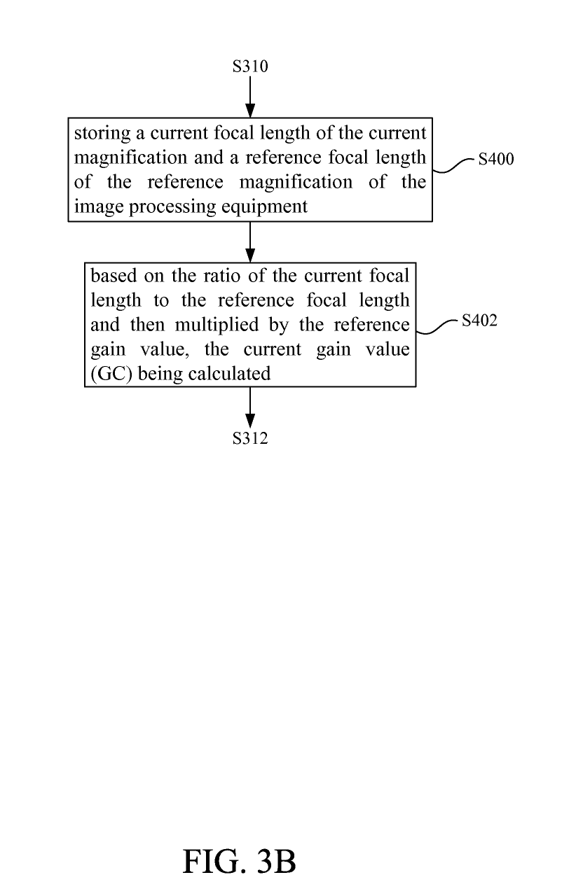

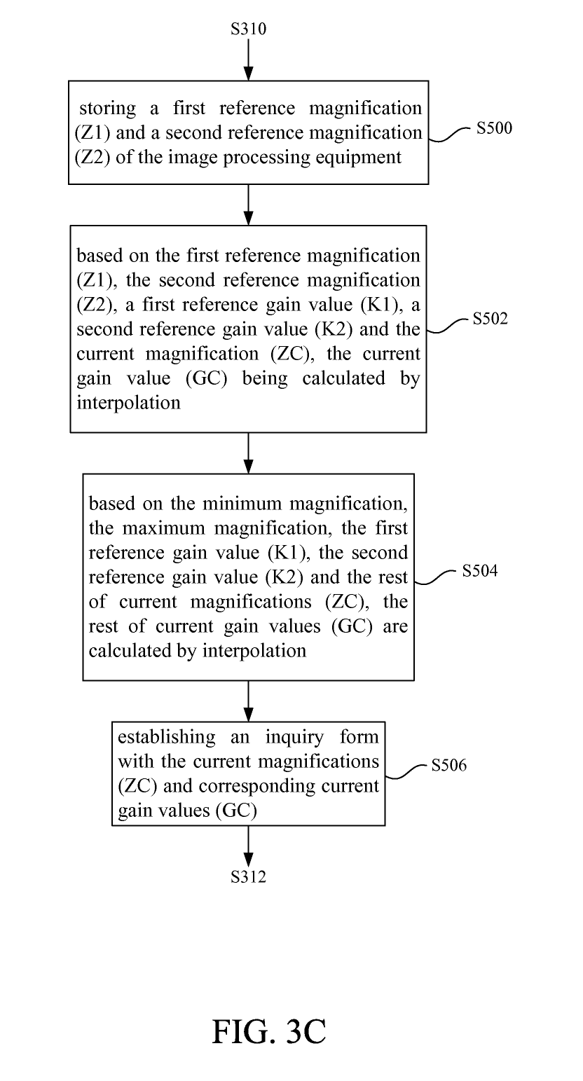

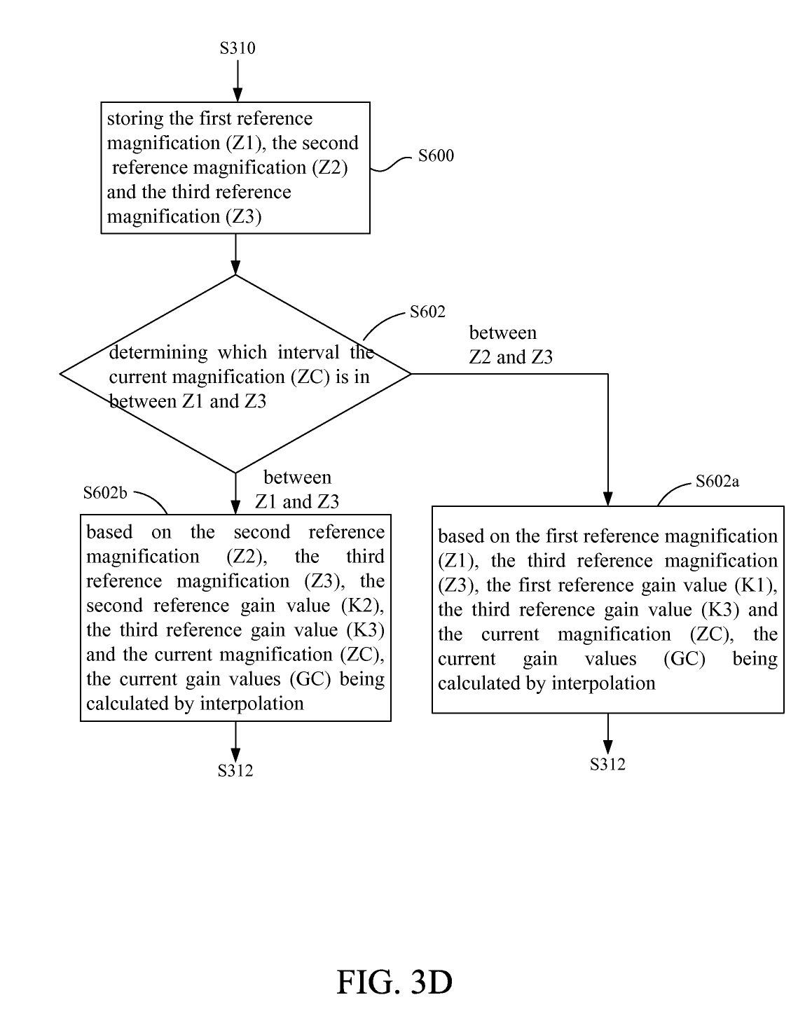

In the first embodiment shown in FIG. 3B, Step S400 is performed after Step S308. In Step S400, the first register 112 stores a current focal length of the current magnification and a reference focal length of the reference magnification of the image processing equipment. In Step S402, based on the ratio of the current focal length to the reference focal length and then multiplied by the reference gain value, the controller 114 calculates the current gain value (GC) and then the method goes back to Step S312.

In the second embodiment shown in FIG. 3C, Step S500 is performed after Step S308. The first register 112 stores a first reference magnification (Z1) and a second reference magnification (Z2) of the image processing equipment. The first reference magnification (Z1) and the second reference magnification (Z2) are corresponding to a first reference gain value (K1) and a second reference gain value (K2) of the optical image stabilizer, respectively. In Step S502, based on the first reference magnification (Z1), the second reference magnification (Z2), the first reference gain value (K1), the second reference gain value (K2), and the current magnification (ZC), the controller 114 calculates the current gain value (GC) corresponding to the current magnification (ZC) by interpolation. The first reference magnification (Z1) is the minimum magnification of the image processing equipment and the second reference magnification (Z2) is the maximum magnification of the image processing equipment.

In Step S504, based on the minimum magnification, the maximum magnification, the first reference gain value (K1), the second reference gain value (K2), and multiple additional current magnifications (ZC), the controller 114 calculates multiple additional current gain values (GC) corresponding to each of the multiple additional current magnifications (ZC) by interpolation. In Step S506, the controller 114 establishes a look-up table with the current magnifications (ZC) and corresponding current gain values (GC), so that when the image processing equipment is adjusted to a current magnification (ZC), a current gain (GC) corresponding to the current magnification (ZC) is used to compensate the optical image stabilizer 102. The method then goes back to Step S312.

In the third embodiment shown in FIG. 3D, Step S600 is performed after Step S308. The first register 112 stores a first reference magnification (Z1), a second reference magnification (Z2), and a third reference magnification (Z3) of the image processing equipment. The first reference magnification (Z1), the second reference magnification (Z2), and the third reference magnification (Z3) are corresponding to a first reference gain value (K1), a second reference gain value (K2), and a third reference gain value (K3) of the optical image stabilizer, respectively. The first reference magnification (Z1) can be, for example, the minimum magnification of the image processing equipment and the third reference magnification (Z3) can be for example the maximum magnification of the image processing equipment.

In Step S602, the controller 114 determines whether the current magnification (ZC) is between the first reference magnification (Z1) and the third reference magnification (Z3) or between the second reference magnification (Z2) and the third reference magnification (Z3). In Step S602a, when the current magnification (ZC) is between the first reference magnification (Z1) and the third reference magnification (Z3), the controller 114, based on the first reference magnification (Z1), the third reference magnification (Z3), the first reference gain value (K1), the third reference gain value (K3), and the current magnification (ZC), calculates the current gain values (GC) corresponding to the current magnifications (ZC) by interpolation. And then the method goes back to Step S312. In Step S602b, when the current magnification (ZC) is between the second reference magnification (Z2) and the third reference magnification (Z3), the controller 114, based on the second reference magnification (Z2), the third reference magnification (Z3), the second reference gain value (K2), the third reference gain value (K3), and the current magnification (ZC), calculates the current gain values (GC) corresponding to the current magnifications (ZC) by interpolation. And then the method goes back to Step S312.

Based on the above, for employing the controller 114 and the second register 116 of the gain calibration device 100, during gain calibration, the present invention uses focal length and gain value of one magnification to quickly calculate a gain value of another magnification by interpolation, or uses one magnification or a number of different ranges of magnifications to accurately calculate a gain value of another magnification. The present invention can calibrate gain value of each magnification and use a calculated gain to compensate gain of the optical image stabilizer 102 instead of using a fixed gain value.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A gain calibration device, adapted to an optical image stabilizer of an image processing equipment, gain calibration device comprising:
an integrator receiving a gyro signal and performing integration on the gyro signals to form integral information;
a first register coupled to the integrator for storing the gyro signal, the integral information, and at least one reference magnification of the image processing equipment, the at least one reference magnification corresponding to at least one reference gain value of the optical image stabilizer;
a second register coupled to the integrator for temporarily storing a current gain value; and
a controller coupling to the first register and the second register for determining whether a current magnification of the image processing equipment is the same as a previous magnification, wherein when the current magnification is not the same as the previous magnification, the controller, based on the at least one reference magnification, the at least one reference gain value, and the current magnification, calculates a current gain value corresponding to the current magnification, and replaces the current gain value that is stored in the second register with the current gain value corresponding to the current magnification.

2. The gain calibration device according to claim 1, wherein the controller, based on the at least one reference magnification, the at least one reference gain value, and the current magnification, calculates the current gain value corresponding to the current magnification by interpolation.

3. The gain calibration device according to claim 1, wherein the first register further stores current focal length of the current magnification and reference focal length of the reference magnification of the image processing equipment.

4. The gain calibration device according to claim 3, wherein the controller, based on the ratio of the current focal length to the reference focal length and then multiplied by the reference gain value, calculates the current gain value.

5. The gain calibration device according to claim 1, wherein the first register stores a first reference magnification and a second reference magnification of the image processing equipment, the first reference magnification and the second reference magnification corresponding to a first reference gain value and a second reference gain value of the optical image stabilizer, respectively.

6. The gain calibration device according to claim 5, wherein the controller, based on the first reference magnification, the second reference magnification, the first reference gain value, the second reference gain value, and the current magnification, calculates the current gain value by interpolation.

7. The gain calibration device according to claim 6, wherein the first reference magnification is a minimum magnification of the image processing equipment, and the second reference magnification is a maximum magnification of the image processing equipment.

8. The gain calibration device according to claim 7, wherein the controller, based on the minimum magnification, the maximum magnification, the first reference gain value, the second reference gain value, and multiple additional current magnifications, calculates multiple additional current gain values corresponding to each of the multiple additional current magnifications by interpolation, and the controller establishes a look-up table with the current magnifications and the current gain values, the look-up table being stored in the first register, whereby when the image processing equipment is adjusted to a current magnification, a current gain corresponding to the current magnification is used to compensate the optical image stabilizer.

9. The gain calibration device according to claim 1, wherein the first register further stores a first reference magnification, a second reference magnification, and a third reference magnification of the image processing equipment, the first reference magnification, the second reference magnification, and the third reference magnification corresponding to a first reference gain value, a second reference gain value, and a third reference gain value of the optical image stabilizer, respectively.

10. The gain calibration device according to claim 9, wherein the controller determines whether the current magnification is between the first reference magnification and the third reference magnification or between the second reference magnification and the third reference magnification.

11. The gain calibration device according to claim 10, wherein when the current magnification is between the first reference magnification and the third reference magnification, the controller, based on the first reference magnification, the third reference magnification, the first reference gain value, the third reference gain value, and the current magnification, calculates the current gain value by interpolation.

12. The gain calibration device according to claim 10, wherein when the current magnification is between the second reference magnification and the third reference magnification, the controller, based on the second reference magnification, the third reference magnification, the second reference gain value, the third reference gain value, and the current magnification, calculates the current gain value by interpolation.

13. The gain calibration device according to claim 9, wherein the first reference magnification is a minimum magnification of the image processing equipment, and the second reference magnification is a maximum magnification of the image processing equipment.

14. The gain calibration device according to claim 1, wherein the second register compensates gain of the optical image stabilizer by the calculated current gain value.

15. A method of gain calibration, adapted to an optical image stabilizer of an image processing equipment, the method comprising the following steps:
(a) activating the optical image stabilizer;
(b) integrating a gyro signal to form integral information;
(c) storing the gyro signal and the integral information;
(d) determining whether a current magnification is the same as a previous magnification, so that when the current magnification is not the same as the previous magnification, the controller reads the current magnification from the image processing equipment;
(e) storing at least one reference magnification and a current gain value of the image processing equipment, the at least one reference magnification corresponding to at least one reference gain value of the optical image stabilizer; and
(f) calculating a current gain value corresponding to the current magnification based on the at least one reference magnification, the at least one reference gain value, and the current magnification.

16. The method of gain calibration according to claim 15, wherein in step (f), the controller, based on the at least one reference magnification, the at least one reference gain value, and the current magnification, calculates the current gain value by interpolation.

17. The method of gain calibration according to claim 15 further comprising step (g) after step (e), wherein a current focal length of the image processing equipment and a reference focal length corresponding to the reference magnification of the image processing equipment are stored.

18. The method of gain calibration according to claim 17 further comprising step (h) after step (g), wherein the current gain value is calculated based on the ratio of the current focal length to the reference focal length multiplied by the reference gain value.

19. The method of gain calibration according to claim 15 further comprising step (e1) after step (e), wherein a first reference magnification and a second reference magnification of the image processing equipment are stored, the first reference magnification and the second reference magnification corresponding to a first reference gain value and a second reference gain value of the optical image stabilizer, respectively.

20. The method of gain calibration according to claim 19 further comprising step (f1) after step (e1), wherein the current gain value is calculated based on the first reference magnification, the second reference magnification, the first reference gain value, the second reference gain value, and the current magnification by interpolation.

21. The method of gain calibration according to claim 20, wherein the first reference magnification is a minimum magnification of the image processing equipment, and the second reference magnification is a maximum magnification of the image processing equipment.

22. The method of gain calibration according to claim 20 further comprising the following steps after step (f1):
(i) based on the minimum magnification, the maximum magnification, the first reference gain value, the second reference gain value, and multiple additional current magnifications, calculating multiple additional current gain values corresponding to each of the multiple additional current magnifications by interpolation; and
(j) establishing a look-up table with the current magnifications and corresponding current gain values, so that when the image processing equipment is adjusted to the current magnification, the current gain corresponding to the current magnification is used to compensate the optical image stabilizer.

23. The method of gain calibration according to claim 20 further comprising step (e2) after step (e), wherein a first reference magnification, a second reference magnification, and a third reference magnification of the image processing equipment are stored, the first reference magnification, the second reference magnification, and the third reference magnification corresponding to the first reference gain value, the second reference gain value and the third reference gain value of the optical image stabilizer, respectively.

24. The method of gain calibration according to claim 23 further comprising step (e3) after step (e2), wherein whether the current magnification is between the first reference magnification and the third reference magnification or between the second reference magnification and the third reference magnification is determined.

25. The method of gain calibration according to claim 24 further comprising step (f2) after step (e3), wherein when the current magnification is between the first reference magnification and the third reference magnification, based on the first reference magnification, the third reference magnification, the first reference gain value, the third reference gain value, and the current magnification, the current gain values is calculated by interpolation.

26. The method of gain calibration according to claim 24 further comprising step (f3) after step (e3), wherein when the current magnification is between the second reference magnification and the third reference magnification, based on the second reference magnification, the third reference magnification, the second reference gain value, the third reference gain value, and the current magnification, the current gain values is calculated by interpolation.

27. The method of gain calibration according to claim 23, wherein the first reference magnification is a minimum magnification of the image processing equipment, and the second reference magnification is a maximum magnification of the image processing equipment.

28. The method of gain calibration according to claim 15 further comprising step (k) after step (f), wherein the optical image stabilizer is compensated by using the current gain value.
